(19) United States
(12) Patent Application Publication
(10) Pub. No.: US 2005/0185412 A1
(43) Pub. Date: Aug. 25, 2005

(54) Vehicle lighting system

(76) Inventor: Bo Hutchinson, Ft. Pierce, FL (US)

Correspondence Address: Bo, HUTCHINSON, 2705 N. Indian River Dr., Ft. Pierce, FL, 34946, US

(21) Appl. No.: 10/785,175

(22) Filed: Feb. 24, 2004

(51) Int. Cl. B60Q 1/00

(52) U.S. Cl. 362/485

(57) ABSTRACT

A lighting system, for vehicles, mounted externally of a truck, recreational vehicle or the like. The lighting system is interconnected with the vehicles lighting system, and has a base-mounting unit for mounting on the vehicle. At each end of the base-mounting unit are interconnecting extension members with universal coupling joints with the lighting units, which can be, disposed at most positions around the vehicle to provide peripheral lighting.

### FIELD OF INVENTION

The present invention relates to a lighting system, suitable for use in vehicles, such as trucks, recreational vehicles or the like.

### BACKGROUND OF THE INVENTION

It is known to have overhead lighting system on vehicles that travel in rural areas to provide a more effective distribution of light. Such lighting systems are generally mounted on the sides or rear sides of vehicles and are largely to supplement additional lighting supply for attending to flat tires, loading or unloading of goods from vehicles, and to attend to any unforeseen breakdowns.

### DESCRIPTION OF THE PRIOR ART

The general configuration is two lights facing forward, mounted on a roll bar or on a bar to hold in position these lights. These bars may clamp onto the rails at the sides of the roof or be bolted directly into the roof. The lights commonly used are either rectangular or circular in shape and are about six to eight inches in diameter. When turned on, they provide substantial improvement to visibility in front of the vehicle, however they do not make any contribution to peripheral needs. These peripheral needs must be addressed with the implementation of several other lights strategically place around the vehicle as seen on tow trucks and other service related vehicles. For most applications, finding mounting locations for peripheral lights is difficult and may require drilling holes in the sheet metal of the vehicle or the construction of complicated brackets. In addition to this, getting the light high enough to adequately do its job is almost impossible in most situations. The combination of these factors severely discourages the use of peripheral lights to most consumers.

### SUMMARY OF THE INVENTION

An object of the present invention is to provide a comprehensive lighting system arranged for moving vehicles, as well as vehicles that are stationary, with an emphasis on rather specifically directed front and peripheral light distribution to enable a much enlarged range of visibility at night, bad weather conditions, and in somewhat rural areas.

The present invention includes a lighting system for vehicles, mounted externally of a vehicle such as a truck or recreational vehicle, in which the lighting system is adapted to be electrically connected to the vehicle's lighting system, comprising a mounting unit having a base member of predetermined configuration adapted for detachable attachment on to the vehicle, at or near each end of the base member of the mounting unit at least an interconnecting extension member is provided on which are mounted lighting members, the interconnecting extension members are linked by universal coupling devices for rotational movement in predetermined selective direction, and the lighting members are provided at its mounting position also with universal coupling devices adapted for movement and light distribution over a predetermined and selective area.

Conveniently, the mounting unit is adapted for detachable mounting by its base member to a vehicle in a collapsed form, and in which the coupling devices are in the form of universal joints adapted to be interconnected and positioned in a collapsed form and disposed substantially parallel to the base member.

Advantageously, the interconnection with the base and the lights during the vehicles driving and driven state is so arranged that the lights beam projections provide additional lighting beams during unusual weather conditions, as well as in dark and difficult rural driving conditions.

The invention will now be described, by the way of example, with reference to the accompanying drawings in which:

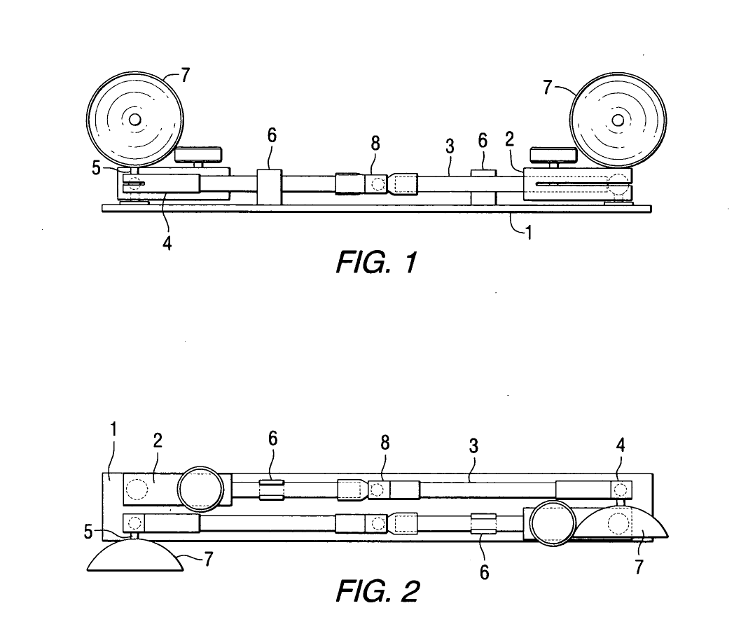

FIG. 1 is a front view according to the present invention in a collapsed form:

FIG. 2 is a plan view from the top depicting the present invention in a collapsed form; and

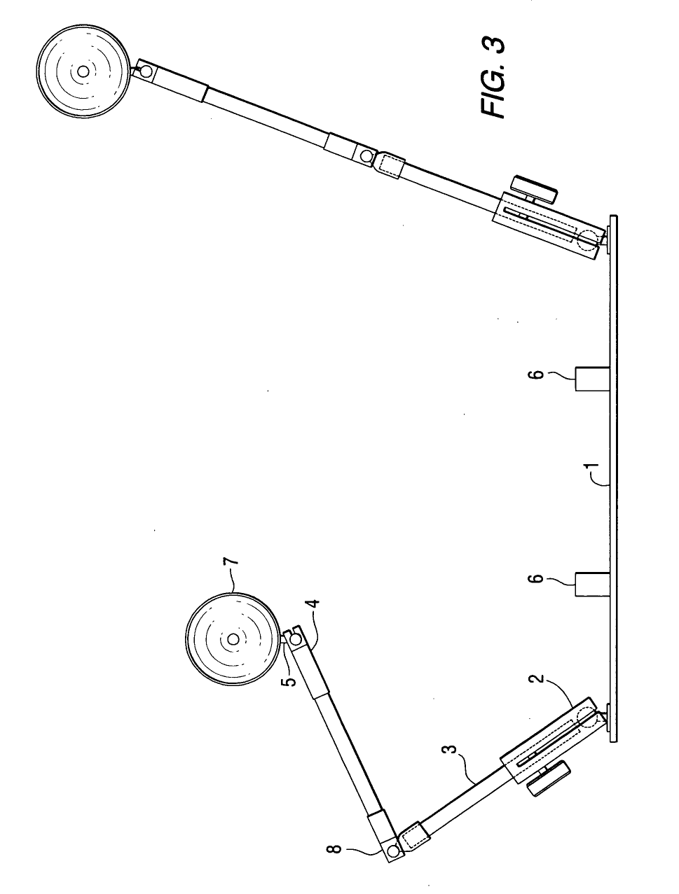

FIG. 3 is a front view according to the present invention in an expanded mode.

With reference to the drawings, FIGS. 1 and 2 illustrate the present invention in a collapsed form suitable for mounting on the top of a truck, ambulance or a vehicle. It illustrates the lighting system, with its mounting base member unit 1, to which at each end of the base unit are interconnecting extension members 3, attached to the base unit by locking ball joints 2 and arranged to be parallel to the base unit. The extension members in the collapsed position are disposed through friction brackets 6, and connected by locking ball joints 2 that are adapted for universal movement. A friction ball joint 4 is located at the opposite end of each extension member 3. The friction ball joint is so positioned in a vertical position so that a light bracket 5 is perpendicular to the base-mounting unit, and a light unit 7 is positioned above the friction ball joint, which enables the light units 7 to provide further peripheral light to the vehicle. It should be noted that the extension members with the coupling arrangement can be so adapted that the extension members with the lighting units 7 are placed one behind the other, and also mounted in opposed directions.

With respect to FIG. 3, the invention is illustrated from the front in an expanded form. The ball joints 2 and 5 coupled to the base unit 1 and the lighting unit 7 can be with both extension members 3 be moved around in different directions. For further ease of directional movement, a further torsional coupling member 8 is disposed at mid point location on each extension member 3. It should be noted and appreciated that the coupling arrangements of each extension member 3 to the base unit 1 could be achieved by varied forms of hinge arrangement (not shown) and similarly the connections of the light units 7 could be linked through to the extension members by hinge or torsional interconnections.

1. A lighting system, for vehicles, mounted externally of a vehicle such as a truck or recreational vehicle, in which the lighting system is adapted to be electrically connected to the vehicle's lighting system, comprising a mounting unit having a base member of predetermined configuration adapted for attachment on to the vehicle, at or near each end of the base member of the mounting unit at least an interconnecting extension member is provided on which are attached lighting members, the interconnecting extension members are linked by universal coupling devices for rotational movement in predetermined selective direction, and the lighting members are provided at its mounting position also with universal coupling devices adapted for movement and light distribution over a predetermined and selective area.

2. A lighting system, as claimed in claim 1, wherein the mounting unit is adapted for detachable mounting by its base member to a vehicle in a collapsed form.

3. A lighting system, as claimed in claim 1, wherein the coupling devices are in the form of universal joints and are so arranged to permit the interconnecting members to be positioned in a collapsed and substantially parallel to the base member.

4. A lighting system, as claimed in claim 1, wherein on the base member of the mounting unit are positioned friction brackets, to enable each interconnecting

5. A lighting system as claimed in claim 4 wherein the interconnecting extension member is co-operatively adapted to be aligned with its corresponding member, so that a light for each lighting member projects a beam of light to provide additional lights during driving.

6. A lighting system, as claimed in claim 1, wherein at least on each extension member substantially at its mid-point is included a further universal coupling device so as to permit further positioning of the lighting member.
